(19) United States
(12) Patent Application Publication
(10) Pub. No.: US 2026/0177186 A1
(43) Pub. Date: Jun. 25, 2026

(54) INSULATING ASSEMBLY AND METHOD OF USE

(71) Applicant: True North Energy Solutions, LLC, Bloomfield Hills, MI (US)

(72) Inventors: Michael Rose, Sylvan Lake, MI (US); Kenneth Stinehart, Pemberville, OH (US)

(21) Appl. No.: 19/426,634

(22) Filed: Dec. 19, 2025

Related U.S. Application Data
(60) Provisional application No. 63/736,128, filed on Dec. 19, 2024.

(51) Int. Cl. F16L 59/02; F16L 59/12

(52) U.S. Cl. CPC F16L 59/026; F16L 59/12

(57) ABSTRACT

An insulating assembly can include a blanket subassembly having a blanket, grommets and tabs and also a strap assembly having a cord, a hook, a washer, a cord lock, and a bulbous member. A method of using can include positioning the blanket subassembly over a structure be insulated; mounting the strap assembly in a first grommet on a first side of the blanket; placing, after positioning, the hook in a second grommet on a second side of the blanket; placing the cord lock in the unlocked configuration after the hook is placed; moving the cord lock along the length of the cord after it is placed in the unlocked configuration toward the first end whereby the blanket subassembly is tightened around the structure; and placing the cord lock in the locked configuration after it has been moved.

### CROSS-REFERENCE TO RELATED APPLICATIONS

This application claims the priority benefit of U.S. Provisional Patent Application Ser. No. 63/736,128 for an INSULATING ASSEMBLY, filed on Dec. 19, 2024, which is hereby incorporated by reference in its entirety.

### BACKGROUND

### 1. Field

The present disclosure relates to a structure that insulates and/or defines a heat shield.

### 2. Description of Related Prior Art

A heat shield is a structure that is designed and thus configured to protect another structure or a human from being damaged, such as being burnt, or overheated by a source of heat. The heat shield can protect by way of one or more modalities, such as dissipating heat, reflecting heat, and/or absorbing heat. Heat shields can be defined by rigid structures and non-rigid structures.

The background description provided herein is for the purpose of generally presenting background context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

An insulating assembly can include a blanket subassembly and a strap assembly. The blanket subassembly can have a blanket and a plurality of grommets fixedly engaged with the blanket. The plurality of grommets can be fixed to the blanket through a plurality of tabs. Each of the plurality of tabs can be fixed to the blanket. Each of the plurality of grommets can be mounted in one of the plurality of tabs. The strap assembly can have a cord, a hook, a washer, a cord lock, and a bulbous member. The cord can extend a length between a first end and a second end. The cord can extend through a first aperture in the hook. A first knot can be defined by the cord at the first end and can prevent the hook from separating from the cord at the first end. The cord can extend through a second aperture in the washer. The hook can be positioned between the washer and the first knot along the length of the cord. The cord can extend through a third aperture in the cord lock. The cord lock can be configured to operate in an unlocked configuration whereby the cord lock is moveable along at least part of the length of the cord and operate in a locked configuration whereby the cord lock is fixed at a position along the length of the cord. The washer can be positioned between the hook and the cord lock along the length of the cord. The cord can extend through a fourth aperture in the bulbous member. A second knot can be defined by the cord at the second end and can prevent the bulbous member from separating from the cord at the second end. The cord lock can be positioned between the washer and the bulbous member along the length of the cord.

A method of using the insulating assembly can include positioning the blanket subassembly over a structure be one of insulated and shielded. The method can also include mounting the strap assembly in a first grommet on a first side of the blanket subassembly. The method can also include placing, after the positioning, the hook of the strap subassembly in a second grommet on a second side of the blanket subassembly opposite to the first side. The method can also include placing, after the placing the hook of the strap subassembly in the second grommet, the cord lock in the unlocked configuration. The method can also include moving, after the placing the cord lock in the unlocked configuration, the cord lock along the length of the cord toward the first end whereby the blanket subassembly is tightened around the structure. The method can also include placing, after the moving, the cord lock in the locked configuration.

### BRIEF DESCRIPTION OF THE DRAWINGS

The detailed description set forth below references the following drawings:

FIG. 1 is a first isometric view of a portion of an insulating assembly according to an exemplary embodiment of the present disclosure in an exemplary operating environment;

FIG. 2 is a second isometric view of the portion of the exemplary insulating assembly in the exemplary operating environment;

FIG. 3 is an isometric view of a strap subassembly that is a component of the exemplary insulating assembly

FIG. 4 is an isometric view of hook that is a component of the exemplary strap subassembly;

FIG. 5 is an isometric view of a washer and cord lock that are components of the exemplary strap subassembly;

FIG. 6 is an isometric view of a bulbous member that is a component of the exemplary strap subassembly; and

FIG. 7 is a third isometric view of the portion of the exemplary insulating assembly in the exemplary operating environment.

### DETAILED DESCRIPTION

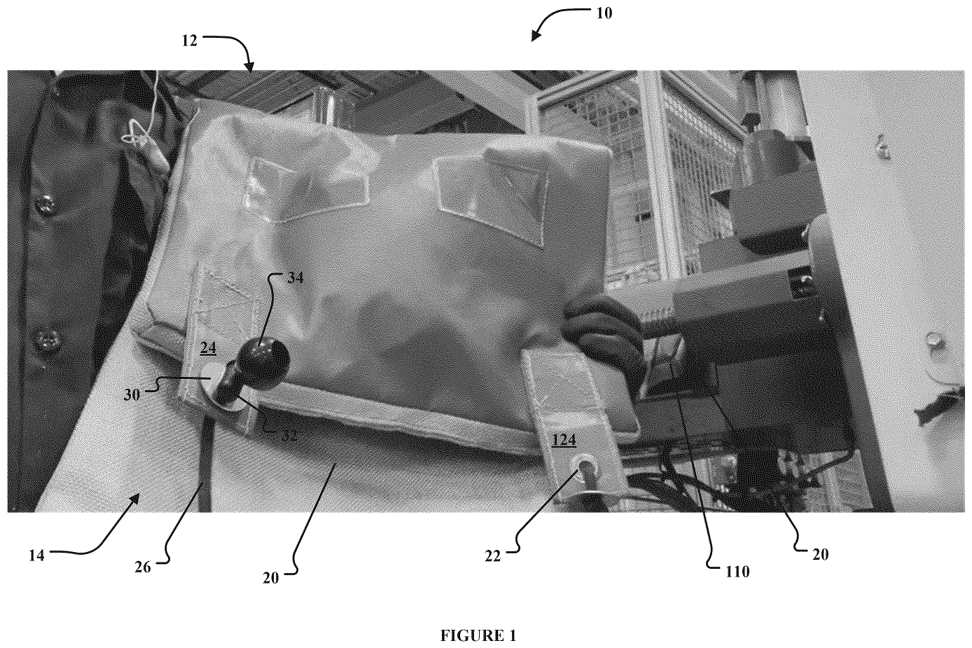

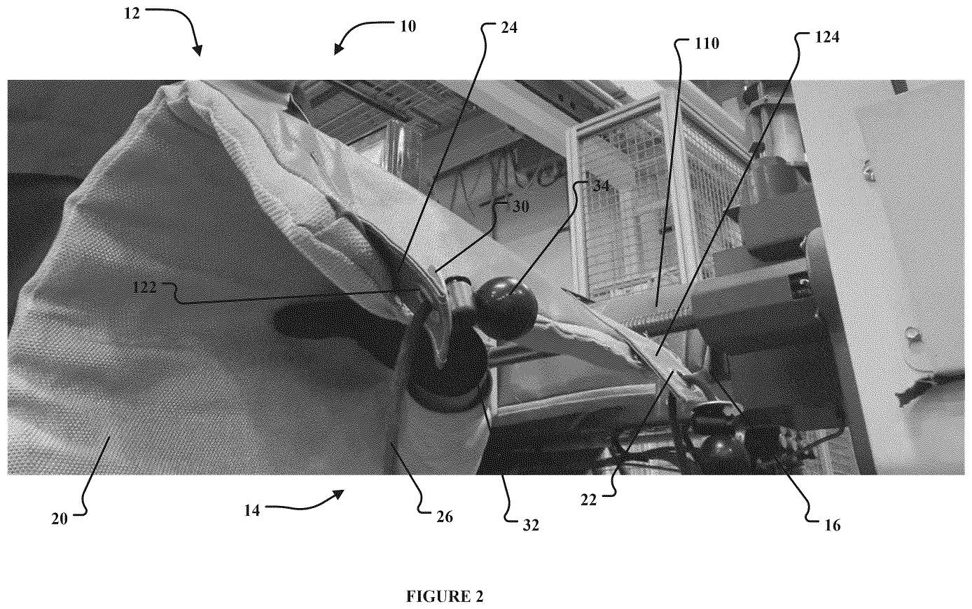

The present disclosure, as demonstrated by the exemplary embodiment described below, provides an insulating assembly that is effective and easy to install and remove. Referring now to FIGS. 1 and 2, an exemplary insulating assembly 10 includes an exemplary blanket subassembly 12 and an exemplary strap subassembly 14. In FIG. 1, portions of the exemplary blanket subassembly 12 and the exemplary strap subassembly 14 are shown; the entire exemplary insulating assembly 10 is not shown. The exemplary insulating assembly 10 is shown in the foreground in FIG. 1 and a second exemplary insulating assembly 110 is shown in the background in FIG. 1. The second exemplary insulating assembly 110 is shown placed over an exemplary shroud 16 which itself is placed over an exemplary barrel (not visible) of a plastic injection mold. Hot, liquid plastic is directed through the exemplary barrel. The exemplary shroud 16 is positioned over the exemplary barrel to prevent an operator of the plastic injection mold from accidentally contacting the exemplary barrel and being burned. The second exemplary insulating assembly 10 is positioned over the exemplary shroud 16 to prevent the operator from accidentally contacting the exemplary shroud 16 and being burned.

The exemplary blanket subassembly 12 has an exemplary blanket 20 and a plurality of exemplary grommets 22, 122. The exemplary blanket 20 is made from one or more materials that is/are to inhibit the passage of heat. The plurality of exemplary grommets 22, 122 are fixedly engaged with the exemplary blanket 20. In the exemplary embodiment, the plurality grommets 22, 122 are fixed to the exemplary blanket 20 through exemplary tabs 24, 124. The exemplary tabs 24, 124 are fixed to the exemplary blanket 20 and each grommet 22, 122 is mounted in one of the exemplary tabs 24, 124.

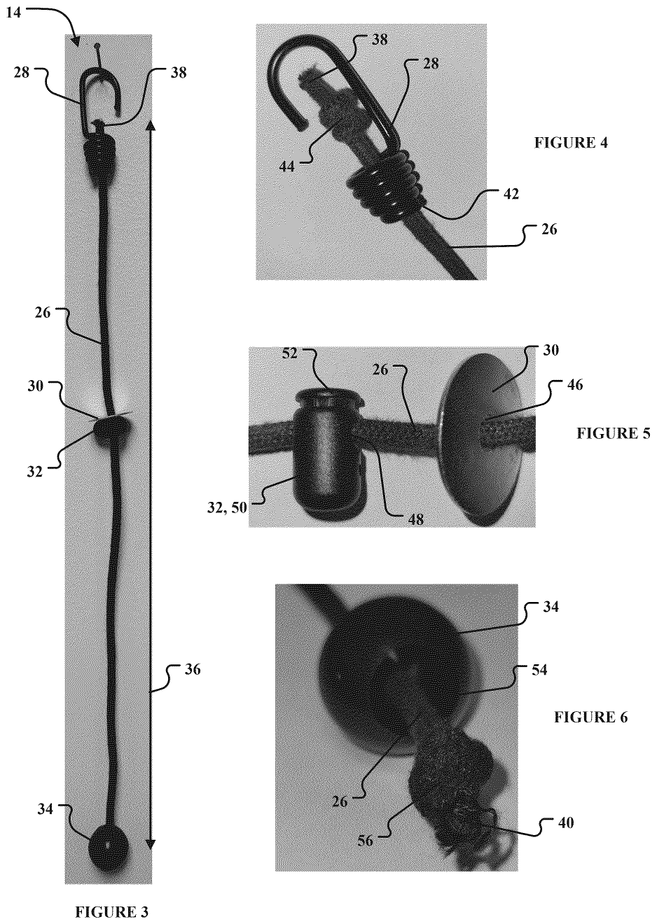

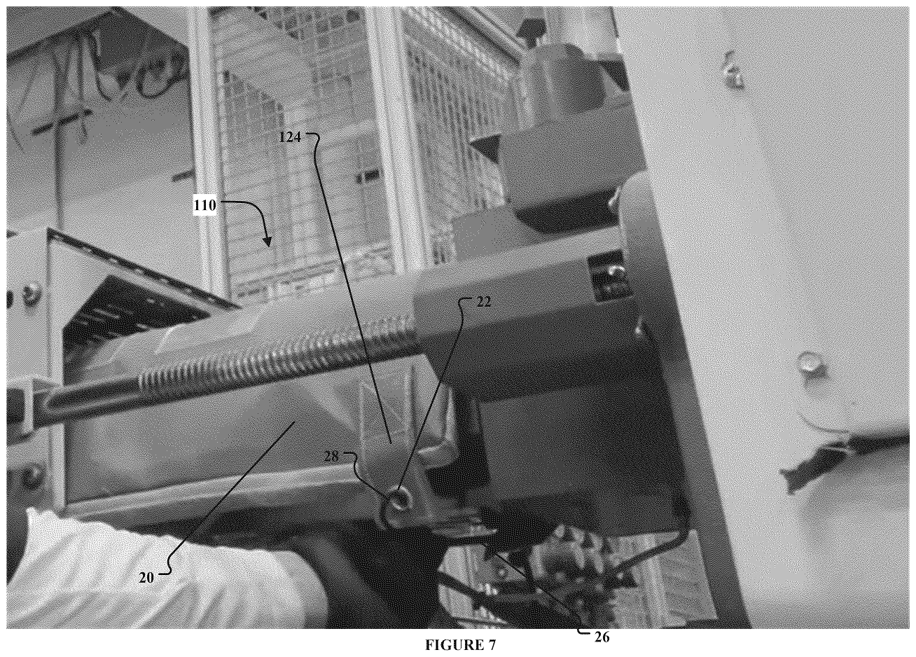

Referring now to FIGS. 3-6, the exemplary strap subassembly 14 has an exemplary cord 26, an exemplary hook 28, an exemplary washer 30, an exemplary cord lock 32, and an exemplary bulbous member 34. The exemplary cord 26 extends an exemplary length 36 between an exemplary first end 38 and an exemplary second end 40. The exemplary cord 26 extends through and an exemplary first aperture 42 in the exemplary hook 28. An exemplary first knot 44 is defined at the exemplary first end 38 and prevents the exemplary hook 28 from separating from the exemplary cord 26 at the exemplary first end 38.

The exemplary cord 26 also extends through an exemplary second aperture 46 in the exemplary washer 30. The exemplary hook 28 is positioned between the exemplary washer 30 and the exemplary first knot 44 along the exemplary length 36 of the exemplary cord 26. The exemplary cord 26 also extends through an exemplary third aperture 48 in the exemplary cord lock 32.

The exemplary cord lock 32 is configured to operate in an unlocked configuration whereby the exemplary cord lock 32 is moveable along at least part of the exemplary length 36 of the exemplary cord 26 and operate in a locked configuration whereby the exemplary cord lock 32 is fixed at a position along the exemplary length 36 of the exemplary cord 26. The exemplary cord lock 32 includes an exemplary body 50 and an exemplary plunger 52. The exemplary cord lock 32 also includes a spring (not visible) positioned in the exemplary body 50 and biasing the exemplary plunger 52 out of the exemplary body 50. The exemplary third aperture 48 is defined in the exemplary body 50 and the exemplary plunger 52 defines another aperture (not visible).

The exemplary cord lock 32 operates in the unlocked configuration when the exemplary plunger 52 is pressed into the exemplary body 50, against the biasing force generated by the spring. When this occurs, the exemplary third aperture 48 and the aperture defined by the exemplary plunger 52 align and allow the exemplary cord lock 32 to move freely along the exemplary length 36 of the exemplary cord 26. When the exemplary plunger 52 is released, the exemplary cord lock 32 operates in the locked configuration and is fixed at a position along the exemplary length 36 of the exemplary cord 26.

The exemplary washer 30 is positioned between the exemplary hook 28 and the exemplary cord lock 32 along the exemplary length 36 of the exemplary cord 26. The exemplary cord 26 also extends through an exemplary fourth aperture 54 in the exemplary bulbous member 34. An exemplary second knot 56 is defined at the exemplary second end 40 and prevents the exemplary bulbous member 34 from separating from the exemplary cord 26 at the exemplary second end 40. The exemplary cord lock 32 is positioned between the exemplary washer 30 and the exemplary bulbous member 34 along the exemplary length 36 of the exemplary cord 26.

In an exemplary approach, for a portion of the manufacture of the exemplary insulating assembly 10, the exemplary second knot 56 can be formed in the exemplary second end 40 of the exemplary cord 26. The exemplary first end 38 of the exemplary cord 26 can be inserted in the exemplary fourth aperture 54 to position the exemplary bulbous member 34 on the exemplary cord 26. Next, the exemplary cord lock 32 can be placed in the unlocked configuration and the exemplary first end 38 of the exemplary cord 26 can be inserted in the exemplary third aperture 48 to position the exemplary cord lock 32 on the exemplary cord 26. Next, the exemplary first end 38 of the exemplary cord 26 can be inserted in the exemplary second aperture 46 to position the exemplary washer 30 on the exemplary cord 26.

Next, the exemplary first end 38 of the exemplary cord 26 can be inserted through a grommet. Next, the exemplary cord 26 can be inserted in the exemplary first aperture 42 to position the exemplary hook 28 on the exemplary cord 26. At this point, the tab in which the grommet is mounted is between the exemplary washer 30 and the exemplary hook 28. Finally, the exemplary first knot 44 can be formed in the exemplary first end 38 of the exemplary cord 26. Strap assemblies can be placed in half of the exemplary grommets 22, 122 and arranged so that, for each pair of exemplary grommets 22, 122 that are on opposite sides of the exemplary blanket 20, one grommet receives an exemplary strap subassembly 14 and the other grommet is not occupied with an exemplary strap subassembly 14.

In an exemplary method of placing the exemplary insulating assembly 10 for operation, the exemplary blanket subassembly 12 can be positioned over a structure that is to be insulated or shielded, such as the exemplary shroud 16. It is noted that the exemplary strap subassembly 14 can be mounted in a first grommet 22 on a first side of the exemplary blanket subassembly 12. In a next step, the exemplary hook 28 of the exemplary strap subassembly 14 can be placed in a second grommet 122 that is on a second side of the exemplary blanket subassembly 12 that is opposite to the first side. Next, the exemplary cord lock 32 can be placed in the unlocked configuration and moved along the exemplary length 36 of the exemplary cord 26 toward the exemplary first end 38 until the exemplary blanket subassembly 12 is tightened around the structure to the extent desired. Finally, the exemplary cord lock 32 can be placed in the locked configuration.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/<2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventors also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. An insulating assembly comprising:
a blanket subassembly having a blanket and a plurality of grommets fixedly engaged with said blanket, wherein said plurality of grommets are fixed to said blanket through a plurality of tabs and wherein each of said plurality of tabs are fixed to said blanket and each of said plurality of grommets is mounted in one of said plurality of tabs; and
a strap assembly having a cord, a hook, a washer, a cord lock, and a bulbous member, wherein said cord extends a length between a first end and a second end, wherein said cord extends through a first aperture in said hook, wherein a first knot is defined by said cord at said first end and prevents said hook from separating from said cord at said first end, wherein said cord extends through a second aperture in said washer, wherein said hook is positioned between said washer and said first knot along said length of said cord, wherein said cord extends through a third aperture in said cord lock, wherein said cord lock is configured to operate in an unlocked configuration whereby said cord lock is moveable along at least part of said length of said cord and operate in a locked configuration whereby said cord lock is fixed at a position along said length of said cord, wherein said washer is positioned between said hook and said cord lock along said length of said cord, wherein said cord extends through a fourth aperture in said bulbous member, wherein a second knot is defined by said cord at said second end and prevents said bulbous member from separating from said cord at said second end, and wherein said cord lock is positioned between said washer and said bulbous member along said length of said cord.

2. The insulating assembly of claim 1 wherein:
said blanket subassembly is further defined as configured to be positioned over a structure that is to be one of insulated and shielded and said strap assembly is further defined as configured to be mounted in a first grommet on a first side of said blanket subassembly;
said hook is further defined as configured to be placed in a second grommet on a second side of said blanket subassembly opposite to the first side; and
said cord lock is further as configured to be placed in the unlocked configuration and moved along said length of said cord toward said first end to whereby said blanket subassembly is tightened around the structure and then placed in said locked configuration.

3. A method of using the insulating assembly of claim 1 comprising:
positioning the blanket subassembly over a structure be one of insulated and shielded;
mounting the strap assembly in a first grommet on a first side of the blanket subassembly;
placing, after said positioning, the hook of the strap subassembly in a second grommet on a second side of the blanket subassembly opposite to the first side;
placing, after said placing the hook of the strap subassembly in the second grommet, the cord lock in the unlocked configuration;
moving, after said placing the cord lock in the unlocked configuration, the cord lock along the length of the cord toward the first end whereby the blanket subassembly is tightened around the structure; and
placing, after said moving, the cord lock in the locked configuration.
